(19) United States
(12) Patent Application Publication
(10) Pub. No.: US 2004/0073886 A1
(43) Pub. Date: Apr. 15, 2004

(54) Program management lifecycle solution

(76) Inventor: Benafsha Irani, San Francisco, CA (US)

Correspondence Address: Donald L. Bartels, Coudert Brothers LLP, Two Palo Alto Square, 3000 E1 Camino Real, Fourth Floor, Palo Alto, CA, 94306-2121, US

(21) Appl. No.: 10/442,833

(22) Filed: May 20, 2003

Related U.S. Application Data
(60) Provisional application No. 60/382,141, filed on May 20, 2002.

(51) Int. Cl. G06F 9/44

(52) U.S. Cl. 717/101

(57) ABSTRACT

A data processing system for enabling at least one stakeholder to manage a project that includes the generation of at least one software program for an end user is disclosed. The system includes a program lifecycle management processor for prompting at least one participant to perform a plurality of tasks such that the participant is guided through a lifecycle process for generating the software program and for enabling at least one stakeholder to monitor and oversee the project and the progress of the software program generation for the project. The system further includes a user interface for enabling role-based access to the data processing system for the at least one participant and the at least one stakeholder and for enabling the at least one participant and the at least one stakeholder to input data to the lifecycle management processor and access data from the lifecycle management processor according to the role-based access. The system preferably includes at least one software tool and a reporting engine. A system is also disclosed for enabling a plurality of stakeholders to manage a project that includes the generation of one or more software programs for an end user. The disclosed invention provides a comprehensive program lifecycle management solution.

### CROSS REFERENCE TO RELATED APPLICATIONS

This application claims the benefit of U.S. Provisional Application No. 60/382,141, filed May 20, 2002, which is incorporated by reference herein.

### FIELD OF THE INVENTION

This invention relates to a data processing system for managing and generating a program for an end user, and more specifically to a program lifecycle management tool for enabling at least one stakeholder to manage a project that includes generating one or more software programs and for guiding a participant through a lifecycle process for generating each program and for also enabling the stakeholder to monitor and oversee the progress thereof.

### BACKGROUND OF THE INVENTION

According to recent statistics, close to half of all programs created and developed by information technology (“IT”) organizations fail. Therefore, today's IT organizations have become increasingly concerned about effective program management. One critical success factor for effective program management is the alignment of goals in generating a program with the roles of the personnel in the IT organization responsible for generating that program. Another critical success factor for effective program management is the early detection of lagging program deliverables. Accordingly, IT organizations typically strive to achieve the following four goals related to effective program management: (1) implementing a full lifecycle program management solution, wherein each program in an IT organization's portfolio is created and developed according to a single and comprehensive lifecycle process; (2) creating a positive feedback loop between all of the personnel involved with generating any given program; (3) increasing visibility and accountability of the personnel involved with generating any given program; and (4) increasing overall return on investment for each program.

In general, to be considered a comprehensive program lifecycle management solution that would enable an IT organization to realize the above four goals and to increase program success rate, a program lifecycle management tool must, at a minimum, enable the IT organization to perform the following five functions. First, the program lifecycle management tool must enable the IT organization to perform real-time monitoring and management of its program in process portfolio. Second, the program lifecycle management tool must enable the IT organization to utilize current industry knowledge and best-practices in generating a program, for example, by using templates. Third, the program lifecycle management tool must enable the IT organization to have a more detailed view or “drill-down” capability to identify problems as early as feasible in each program's lifecycle. Fourth, the program lifecycle management tool must enable the IT organization to effectively balance the lifecycle process with creativity. Finally, the program lifecycle management tool must enable the IT organization to continually strive to reduce the overall time to progress through the program lifecycle process.

There are a number of program lifecycle management tools well known in the art that may be used by an IT organization for program lifecycle management. Typically, these tools can be classified into one or more of the following four different categories: (1) tools that enable the tracking of steps within a lifecycle process; (2) tools that provide visibility into and status of the overall program management lifecycle process, such as program portfolio management reporting; (3) tools that help manage user access, the overall program management lifecycle flow, and integration with other applications; and (4) tools that contain intellectual property in the form of specific industry knowledge and that help implement best practices. However, no single prior art tool in the industry is a complete lifecycle management solution that enables an IT organization to perform the above identified five minimum functions. What is needed is an improved and more complete lifecycle management solution.

### SUMMARY OF THE INVENTION

The present invention is directed at addressing the above-mentioned shortcomings, disadvantages and problems of the prior art. Broadly stated, the present invention is directed to a data processing system for enabling at least one stakeholder to manage a project that includes the generation of at least one software program for an end user, comprising: a program lifecycle management processor for prompting at least one participant to perform a plurality of tasks such that the at least one participant is guided through a lifecycle process for generating the software program and for enabling at least one stakeholder to monitor and oversee the project and the progress of the software program generation for the project; a user interface for enabling role-based access to the data processing system for the at least one participant and the at least one stakeholder and for enabling the at least one participant and the at least one stakeholder to input data to the lifecycle management processor and access data from the lifecycle management processor according to the role-based access. Broadly stated, the lifecycle process comprises the steps of: prompting the participant to identify and describe a program concept, the lifecycle management processor enabling the participant to proceed to the next step in the lifecycle process when the program concept satisfies at least one predetermined criterion; prompting the participant to define the desired scope and functionality of the program, the lifecycle management processor enabling the stakeholder to evaluate the program scope and functionality and to proceed to the next step in the lifecycle process when the stakeholder determines that the program scope and functionality are feasible; prompting the participant to establish a priority for completing the program, the lifecycle management processor enabling the participant to proceed to the next step in the lifecycle process once priority has been established based on at least one predetermined criterion; prompting the participant to identify tools to be used in implementing the program; prompting the participant to identify the detailed requirements for the program and to create a detailed functional and module level work plan for the program using the tools, the lifecycle management processor enabling the stakeholder to evaluate the detailed requirements and the detailed functional and module level work plan and enabling the participant to proceed to the next step in the lifecycle process when the stakeholder determines that the work plan satisfies the detailed requirements; prompting the participant to develop the completed program using the detailed requirements and the tools; prompting the participant to create a systems test strategy and plan for the completed program and to perform system testing based on the systems test plan, the lifecycle management processor enabling the participant to proceed to the next step in the lifecycle process when the program satisfactorily performs pursuant to the systems test plan; and prompting the participant to create an acceptance test plan for the completed program and to perform acceptance testing based on the acceptance test plan, the lifecycle management processor enabling the participant to proceed to the next step in the lifecycle process when the program satisfactorily performs pursuant to the acceptance test plan.

An object of the present invention is that it provides an improved and comprehensive program lifecycle management tool for enabling at least one stakeholder to manage a project that includes generating one or more software programs and for guiding a participant through a lifecycle process for generating each program and for also enabling the stakeholder to monitor and oversee the progress thereof.

One advantage of the present invention is that it enables real-time program status monitoring for identifying authority, accountability and responsibility for each task to be performed in the lifecycle process. Accordingly, a dashboard, in the form of a real time snapshot of the status of a program, is provided for everyone from an executive stakeholder to a program generator/participant, i.e., a person in the group that is generating the program (“a program member”). A secure role-based access to different views of a program in the process of being generated is also provided.

Another advantage of the present invention is that it provides templates and examples for best-practices in program lifecycle management to, for instance, enable a program member to perform one or more tasks.

Another advantage of the present invention is that it provides a central program deliverables repository.

Yet another advantage of the present invention is that it provides interfaces to industry standard software tools.

Still another advantage of the present invention is that it provides a built-in reporting engine and intuitive user interface.

Another advantage of the present invention is that it provides browser-based, thin client access from any system for all participants and stakeholders.

Another advantage of the present invention is that it provides metrics reporting for programs generated using the present invention.

Still another advantage of the present invention is that it enables management of deliverables, milestones and financial information such as costs associated with multiple programs.

### BRIEF DESCRIPTION OF THE DRAWINGS

The forgoing aspects and attendant advantages of the present invention will become more readily appreciated by reference to the following detailed description, when taken in conjunction with the accompanying drawings, wherein:

FIG. 1 is a block diagram of an architecture for a data processing system according to an embodiment of the present invention;

FIG. 2 is a flow diagram of a lifecycle process according to a preferred embodiment of the present invention that is enabled by the data processing system of FIG. 1;

FIG. 3 illustrates the details of step one in the preferred lifecycle process, including the key participants and stakeholders;

FIG. 4 illustrates the details of step two in the preferred lifecycle process, including the key participants and stakeholders;

FIG. 5 illustrates the details of step three in the preferred lifecycle process, including the key participants and stakeholders;

FIG. 6 illustrates the details of step four in the preferred lifecycle process, including the key participants and stakeholders;

FIG. 7 illustrates the details of step five in the preferred lifecycle process, including the key participants and stakeholders;

FIG. 8 illustrates the details of step six in the preferred lifecycle process, including the key participants and stakeholders;

FIG. 9 illustrates the details of step seven in the preferred lifecycle process, including the key participants and stakeholders;

FIG. 10 illustrates the details of step eight in the preferred lifecycle process, including the key participants and stakeholders;

FIG. 11 illustrates the details of step nine in the preferred lifecycle process, including the key participants and stakeholders; and

FIG. 12 is a block diagram that illustrates a URL site map according to a preferred embodiment of the present invention.

### DETAILED DESCRIPTION OF THE INVENTION

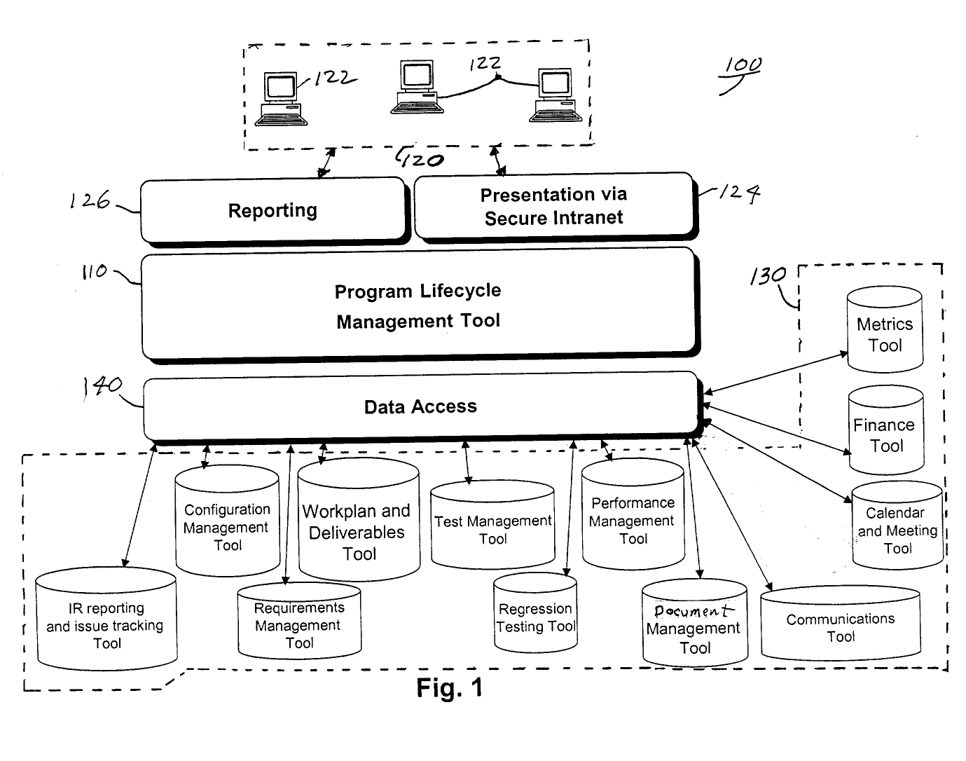

FIG. 1 is a block diagram of an architecture for a data processing system 100 according to a preferred embodiment of the present invention. Data processing system 100 is used for managing a project comprising one or more programs and for generating each program for an end user and for enabling at least one stakeholder to monitor and oversee the progress of a lifecycle process for the program generation. Data processing system 100 comprises a lifecycle management processor (also referred to herein as a “program lifecycle management tool”) 110 for prompting at least one participant to perform a plurality of tasks such that said participant is guided through a lifecycle process for generating said software program and for enabling at least one stakeholder to monitor and oversee the progress of the software program generation throughout the lifecycle process and the progress of the project.

A user of data processing system 100 typically has, but is not limited to, at least one of the following roles in an IT organization and also any software development process: Senior Management, Executives, Application managers, Channel managers, Developers, Finance managers, IT architects, Process managers, Product managers, Program managers, Quality Assurance (“QA”) managers, Reporting analysts, Requirements analysts, Strategists, and Technical managers or any other role as designated by the IT organization. The data processing system 100 according to the preferred embodiment of the present invention is not limited to use by users in an IT organization, but can also be used in any software development process. Typically, a participant/program member is associated with at least one program being generated, but may be associated with multiple programs in the IT organization's “programs in process” portfolio. A stakeholder is typically a Senior Vice President, Senior Management, the IT organization management, a Program Manager, and representatives of the IT organization, as designated. An end user is any individual or any entity that will use the program once it is released, and may include customers and clients of the IT organization.

Data processing system 100 also comprises a user interface 120 for enabling the participant and the stakeholder to input data in response to at least one request for data from the lifecycle management processor as the lifecycle management processor guides the participant through the lifecycle process. The user interface is enabled through the use of an industry standard personal computing system 122, such as a desktop or a laptop computer. For data processing system 100, the user interface is alternatively enabled through the use of a browser-based such that URL pages enable thin client access to users of the program lifecycle processing system via a secured system that is networked in some conventional way, such as via the Internet or an extranet networking system. Accordingly, software installation on individual desktop computers that are part of the network is not required. Preferably, each user will have access to a computing system 122 that runs software such as Windows 95, 98, NT, ME, 2000 or XP with Microsoft IE 4.0 or a later version for providing a user interface. Each personal computing system 122 is also preferably configured to allow the user to access a reporting function 126 and a presentation function 124, preferably through a secured intranet connection. The reporting function 126 is preferably enabled through at least one built-in industry standard reporting engine such as Actuate, Brio, Business Objects, or Crystal Reports, and is used to publish real-time reports from data gathered as the participant is guided through the lifecycle process. Data processing system 100 also preferably comprises a plurality of software tools used to implement the lifecycle process steps. These tools may be integrated within the lifecycle management processor, but are typically industry standard tools. A data processing system according to a preferred embodiment of the present inventions includes the following software tools 130: an incident report (“IR”) tracking and issue management/tracking tool; a configuration management tool; a requirements management tool; a workplan and deliverables tool; a test management tool; a regression testing tool; and a performance management tool.

The software tools 130 also preferably includes a calendar and meeting tool for enabling a stakeholder to generate and manage a calendar and meetings for managing the project and the program generation. A communications tool is also preferably provided for enabling communication between participants and stakeholders. Preferably, the calendar and meeting tool and communications tool are provided in a single software tool such as MS Outlook or Lotus Notes. The data processing system 100 enables role-based access to the software tools. For example, the system 100 allows role-based access such that only certain users are permitted access for modifying a prearranged meeting time.

The program lifecycle management processor 110 enables users to have role-based access to predefined views of the status of the program generation. The program lifecycle management processor 110 enables a role-based predetermined view of the status of the project and the program generation for each participant and stakeholder preferably via the internet so as to provide a real time snapshot of the status for the participant and the stakeholder. The program lifecycle management processor 110 enables role-based access for controlling the ability of the participants and the stakeholders to view the status and execute the program generation, which, broadly stated, preferably comprises the following steps: causing the stakeholder to assign roles to each the participant and said stakeholder in order to restrict access to a subset of said information based on said assigned role; causing the stakeholder to establish predetermined security for each assigned role such that the levels of detail about the program and the program status that is accessible to the participant and the stakeholder is predetermined for the assigned role. For role-based access, the program lifecycle management processor 110 also preferably enables the participant and the stakeholder to select one of the predetermined levels of detail enabled for the assigned role of the participant and the stakeholder. In other words, depending on the user's role, there may be more than one level of detail enabled for a user to choose from.

Preferably, software tools 130 includes a document management tool for enabling the participant and the stakeholder to view and access files from a central deliverables repository. The view and access for the user are restricted based on the participant's and the stakeholder's assigned role.

Also preferably included is an industry standard finance tool and a metrics tool for: determining metrics, which are steps used to verify a particular performance measurement, e.g., return on investment (“ROI”); time-keeping; expense tracking; providing a human resource management system (HRMS); and finance integration associated with each program in the portfolio. The metrics tool also preferably enables metrics reporting for each program generated using the lifecycle process. Those of ordinary skill in the art will realize that data processing system 100 may be designed using different industry standard tools that meet the predetermined parameters of the system. Data processing system 100 also preferably comprises at least one data storage unit 140 for storing and providing subsequent access to the data input by the participant and the stakeholder via the user interface, for each program in the IT organization's program portfolio.

An advantage of the present invention is that the lifecycle management processor 110 and the user interface 120 are preferably configured to enable real-time program status monitoring for identifying authority, accountability and responsibility for each task that is to be performed in the lifecycle process. As discussed in more detail below, this is enabled by designing the lifecycle management process to generate a dashboard, preferably through http URL pages, for everyone from the stakeholders to the participant/program members, wherein a secure role-based access to different views of the program's status may be obtained.

Data processing system 100 may be used by an IT organization to generate one program and to monitor the status of the generation of that single program. However, a key advantage of the present invention is that data processing system 100 is preferably used by the IT organization to generate multiple programs. Moreover, a stakeholder is able to perform real-time monitoring of deliverables, milestones and costs associated with multiple programs as each program progresses through the lifecycle process, so that accountability is more easily maintained. This visibility and accountability enables early detection and correction of problems, which will enable a higher success rate in program generation in a shorter period of time. The IT organization can, thereby, realize a greater ROI for each successful program generated using data processing system 100.

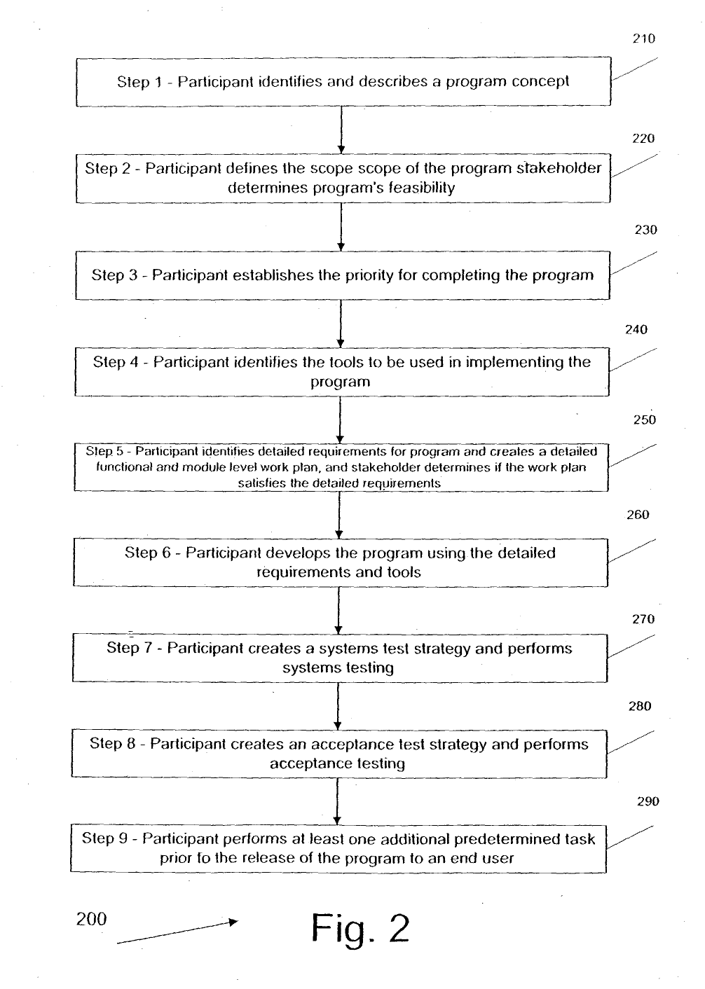

FIG. 2 is a flow diagram of a lifecycle process 200 according to a preferred embodiment of the present invention that is enabled by the data processing system of FIG. 1. Lifecycle process 200 preferably comprises steps one (1) through nine (9), indicated by boxes 210 through 290.

Step 1 (box 210) in lifecycle process 200 is to “Develop a vision” for causing the participant to identify and describe a program concept. The lifecycle management processor enabling the participant to proceed to the next step in the lifecycle process when the program concept satisfies at least one predetermined criterion.

Step 2 (box 220) in lifecycle process 200 is to “Establish scope and feasibility” for causing the participant to define the desired scope and functionality of the program. The lifecycle management processor enabling the stakeholder to evaluate the program scope and functionality and to enable the participant to proceed to the next step in the lifecycle process when the stakeholder determines that the program scope and functionality is feasible.

Step 3 (box 230) in lifecycle process 200 is to “Finalize and prioritize the business case” for causing the participant to establish the priority for completing the program. The lifecycle management processor enabling the participant to proceed to the next step in the lifecycle process once priority has been established based on at least one predetermined criterion.

Step 4 (box 240) in lifecycle process 200 is to “Set-up program tools” for causing the participant to identify tools to be used in implementing the program.

Step 5 (box 250) in lifecycle process 200 is to “Define requirements” for causing the participant to identify the detailed requirements, both business requirements and design requirements, for the program and to create a detailed functional and module level work plan for the program using the tools. The lifecycle management processor enabling the stakeholder to evaluate the detailed functional and module level work plan and to enable the participant to proceed to the next step in the lifecycle process when the stakeholder determines that the work plan satisfies the detailed requirements.

Step 6 (box 260) in lifecycle process 200 is to “Develop project” for causing said participant to develop the completed program using said detailed requirements and said tools.

Step 7 (box 270) in lifecycle process 200 is to “Perform system testing” for causing the participant to create a systems test strategy and plan for the completed program and to perform system testing based on the systems test plan. The lifecycle management processor enabling the participant to proceed to the next step in the lifecycle process when the program satisfactorily performs pursuant to the systems test plan.

Step 8 (box 280) in lifecycle process 200 is to “Perform acceptance testing” for causing the participant to create an acceptance test plan for the completed program and to perform acceptance testing based on the acceptance test plan. The lifecycle management processor enabling the participant to proceed to the next step in the lifecycle process when the program satisfactorily performs pursuant to the acceptance test plan.

Step 9 (box 290) in lifecycle process 200 is to “Release” the program for causing the participant to perform at least one additional predetermined task prior to the release of the program to the end user. One of ordinary skill in the art would realize that Step 9 could be performed by participants who are employees of the IT organization or by persons outside of the IT organization who would then be one or more designated participant users of the system 100.

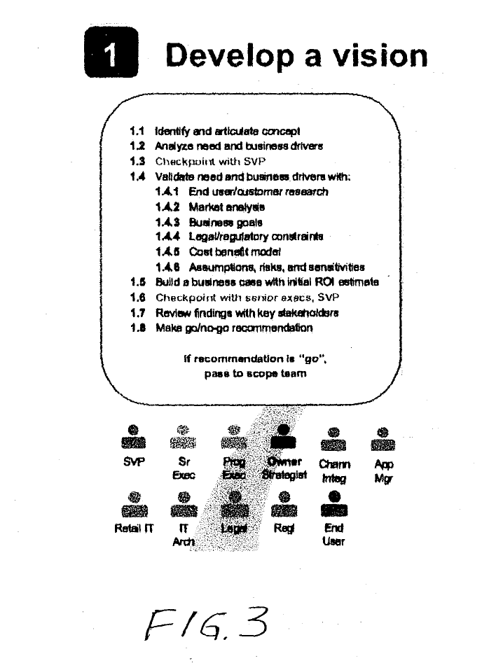

FIGS. 3 through 11 illustrate preferred tasks performed by a participant or a stakeholder in each of the nine steps in the lifecycle process. Another advantage of data processing system 100 is illustrated by reference to the program's deliverables. Data processing system 100 is preferably designed so as to be a central deliverables repository such that all program deliverables may be accessed through the lifecycle management processor 110.

FIG. 3 illustrates the details of step one in the preferred lifecycle process, including the key participants and stakeholders. Step 1 is to Develop a vision. The sub-steps are as follows.

1.1 Identify and articulate concept. Based on proactive research, business unit requests, IT architect suggestions, or IT leadership, identify and articulate technology innovations that enable business improvement.

1.2 Analyze need and business drivers. Research what business needs dictate technological innovation.

1.3 Checkpoint with SITE (Senior IT Executive), to review findings.

1.4 Validate need and business drivers with:

1.4.1 End user/customer research;

1.4.2 Market analysis;

1.4.3 Business goals;

1.4.4 Legal/regulatory constraints;

1.4.5 Cost benefit model, for application components; and

1.4.6 Assumptions, risks, and sensitivities.

1.5 Build a business case with initial ROI estimate. Create business case outline including time to market analysis and initial ROI estimate.

1.6 Checkpoint with senior execs, SITE. Present business case to senior executives and SITE, and obtain approval of preliminary results.

1.7 Review findings with key stakeholders. Present preliminary business case results and obtain feedback.

1.8 Make go/no-go recommendation, based on go/no-go decision scorecard. If recommendation is “go”, pass to scope team.

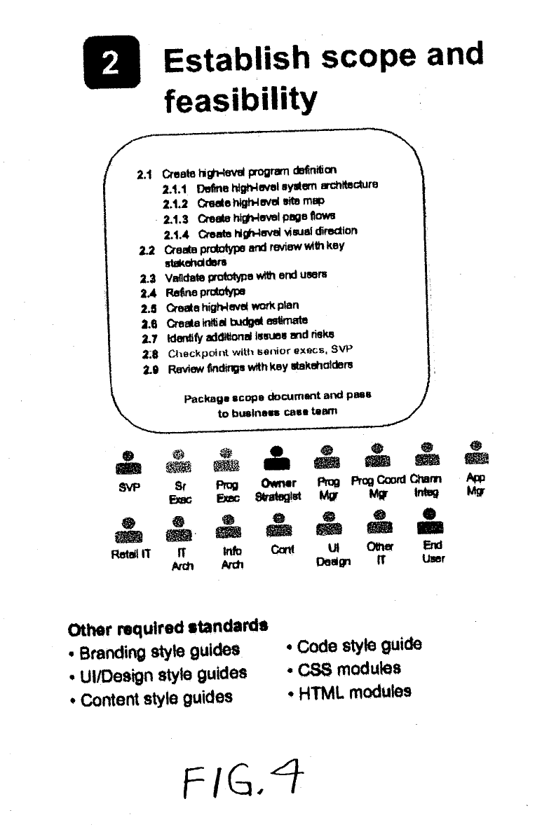

FIG. 4 illustrates the details of step two in the preferred lifecycle process, including the key participants and stakeholders. Step 2 is to Establish scope and feasibility. The sub-steps are as follows.

2.1 Create high-level program definition, describing final deliverable(s) based on the business case outline:

2.1.1 Define high-level system architecture, including hardware, software and network requirements;

2.1.2 Create high-level site map, showing all page interconnectivity (links);

2.1.3 Create high-level page flows, indicating overall functionality and key decision points; and

2.1.4 Create high-level visual direction, indicating overall functionality and key decision points.

2.2 Create prototype and review with key stakeholders. Create prototype using site map, visual direction, and page flows and review completed prototype with stakeholders.

2.3 Validate prototype with end users. Conduct user interface (“UI”) trials to validate concept with end users, typically via a stakeholder validating the prototype from the perspective of an end user or through market testing by individuals who might typically be end users of the program, such as customers or clients.

2.4 Refine prototype and update site map, architecture diagram, visual direction, and page flows to reflect changes.

2.5 Create high-level work plan. Using updated information create a high-level work plan.

2.6 Create initial budget estimate. Using high-level work plan create initial budget.

2.7 Identify additional issues and risks. Document and address all program level issues and risks.

2.8 Checkpoint with senior execs, SITE. Present final prototype, review high-level project plan and budget estimates. Document all program level issues and risks identified in final review.

2.9 Review findings with key stakeholders. Present final prototype to key stakeholders and review high-level project plan and budget estimates. Document all program level issues and risks identified in final review. Package scope document and pass to business case team

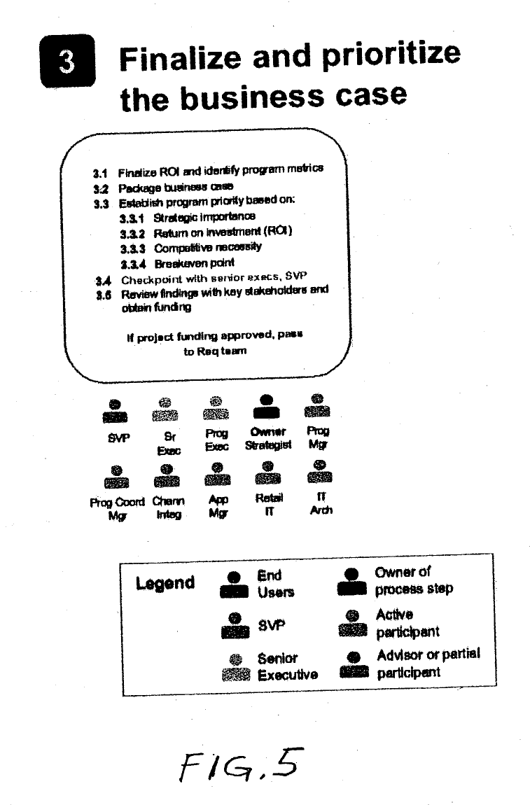

FIG. 5 illustrates the details of step three in the preferred lifecycle process, including the key participants and stakeholders. Step 3 is to Finalize and prioritize the business case. The sub-steps are as follows:

3.1 Finalize ROI and identify program metrics. Project ROI over time (6, 12, 18, and 24 months) and identify metrics that will be used to calculate ROI.

3.2 Package business case, to include: architecture diagram, site map, flow diagram, visual direction, prototype, high-level project plan, budget estimates, program level issue tracking, go/no-go scorecard.

3.3 Establish program priority based on:

3.3.1 Strategic importance;

3.3.2 Return on investment (ROI);

3.3.3 Competitive necessity; and

3.3.4 Breakeven point.

3.4 Checkpoint with senior execs, SITE. Present final business case package to senior executives and SITE and select key release management metrics. Document all program level issues and risks identified during review.

3.5 Review findings with key stakeholders and obtain funding. Present final business case package to key stakeholders, and obtain funding approval. Document all program level issues and risks identified during review. If project funding approved, pass to Requirements team.

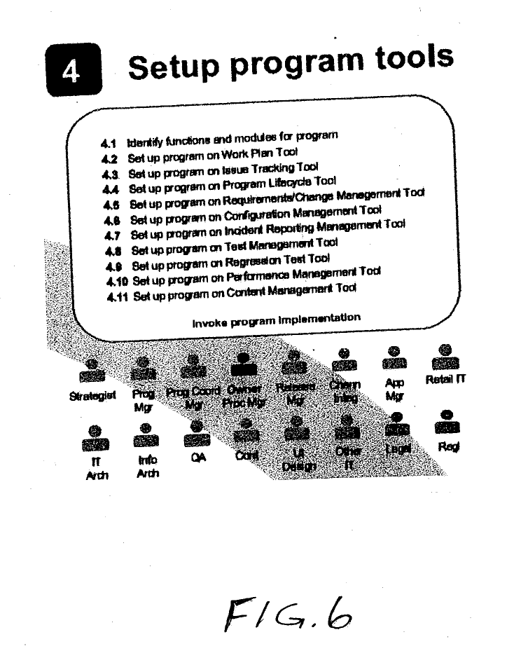

FIG. 6 illustrates the details of step four in the preferred lifecycle process, including the key participants and stakeholders. Step 4 is to Setup program tools. The sub-steps are as follows:

4.1 Identify functions and modules for program. Based upon business case objectives, identify high-level functional and module areas.

4.2 Set up program on Work Plan Tool

4.3 Set up program on Issue Tracking Tool

4.4 Set up program on Program Lifecycle Tool

4.5 Set up program on Requirements/Change Management Tool

4.6 Set up program on Configuration Management Tool

4.7 Set up program on Incident Reporting Management Tool

4.8 Set up program on Test Management Tool

4.9 Set up program on Regression Test Tool

4.10 Set up program on Performance Management Tool

4.11 Set up program on Content Management Tool. Invoke program implementation. The Content Management Tool is an industry standard tool used to manage the content for the development of the present invention.

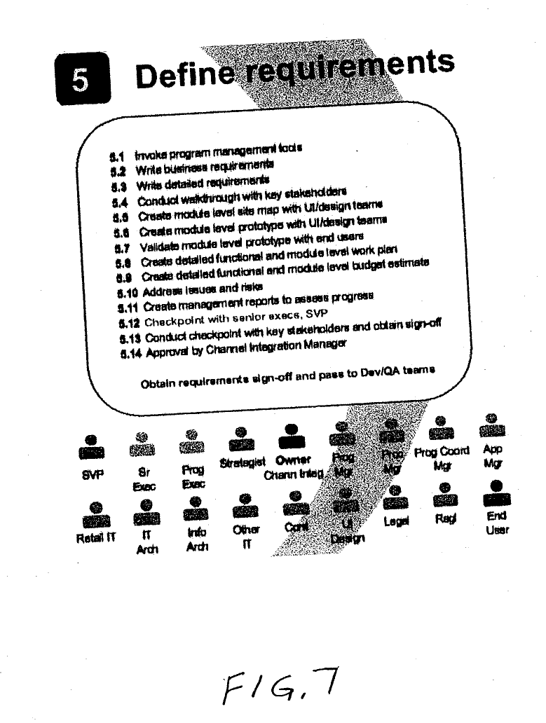

FIG. 7 illustrates the details of step five in the preferred lifecycle process, including the key participants and stakeholders. Step 5 is to Define requirements, both business and design requirements. The sub-steps are as follows:

5.1 Invoke program management tools. Invoke program lifecycle management, issue tracking, work plan, and requirements/change management tools according to defined processes.

5.2 Write business requirements based on the identified functional and module areas.

5.3 Write detailed requirements based on the identified functional and module areas.

5.4 Conduct walkthrough with key stakeholders. Review finalized requirements with key stakeholders and ensure consensus is achieved.

5.5 Create module level site map with UI/design teams using high-level site map. Refine the site map developed in Step 2. Establish scope and feasibility with the design and UI teams to incorporate branding, UI/design and content style guides.

5.6 Create module level prototype with UI/design teams using high-level prototype. Refine the site map developed in Step 2 (Establish scope and feasibility) with the design and UI teams to incorporate branding, UI/design and content style guides.

5.7 Validate module level prototype including UI/design features with end users, tipically via a stakeholder validating the prototype from the perspective of an end user or trough market testing by individuals who might typically be end users of the program, such as customers or clients. Conduct end-user trials utilizing the updated prototype, including the UI/ designed features.

5.8 Create detailed functional and module level work plan. Using updated information create a detailed functional and module level work plan.

5.9 Create detailed functional and module level budget estimate. Using update information create a detailed budget.

5.10 Address issues and risks. Readdress already identified assumptions. Document and address all program level issues and risks.

5.11 Create management reports to assess progress. Create reports utilizing data from: the incident report (“IR”), which tracks defects in the software code; requirements/change management; and configuration control systems.

5.12 Checkpoint with senior execs, SITE. Present final requirements package to key stakeholders and review detailed functional and module level work plan and budget estimates. Document all program level issues and risks identified during review.

5.13 Conduct checkpoint with key stakeholders and obtain sign-off. Present final requirements package to key stakeholders and review detailed functional and module level and budget estimates. Document all program level issues and risks identified in final

5.14 Approval by Channel Integration Manager. Sign-off document should be signed by Channel Manager, Application Manager, Program Manager, and Program Coordination Manager.

5.15 Approval by Executive Owner and Program Management Executive Owner. Obtain requirements sign-off and pass to development and quality assurance teams.

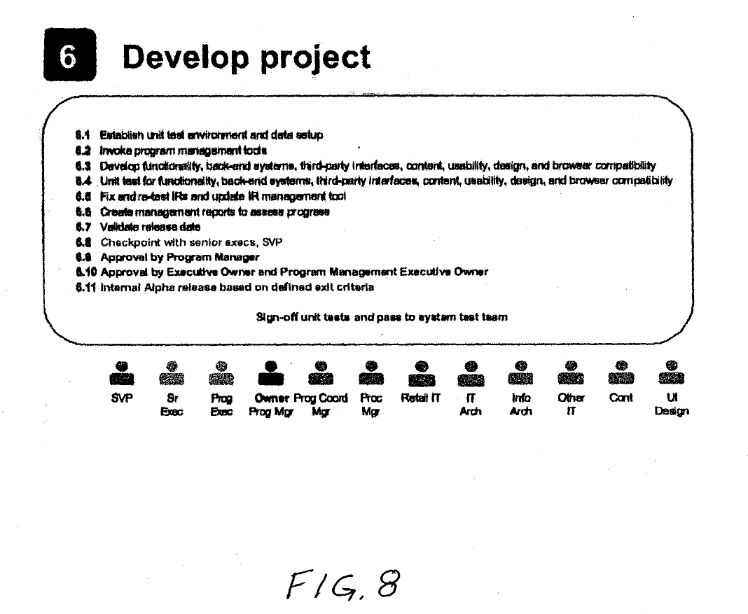

FIG. 8 illustrates the details of step six in the preferred lifecycle process, including participants and stakeholders. Step 6 is to Develop project. The sub-steps are as

6.1 Establish unit test environment and data setup for program.

6.2 Invoke program management tools. Invoke program lifecycle management, issue tracking, work plan, requirements/change management, and incident reporting management tools according to the defined processes.

6.3 Develop functionality, back-end systems, third-party interfaces, content, usability, design, and browser compatibility.

6.4 Unit test for functionality, back-end systems, third-party interfaces, content, usability, design, and browser compatibility. Conduct tests and enter IR information using the IR management tool.

6.5 Fix and re-test IRs and update IR management tool.

6.6 Create management reports to assess progress. Create reports utilizing data from the IR, requirements/change management and configuration control systems.

6.7 Validate release date based on implemented requirements, unit test results and IR analysis.

6.8 Checkpoint with senior execs, SITE. Review unit test results and exit criteria. Document all issues and risks identified during review.

6.9 Approval by Program Manager. Sign-off document should be signed by the program manager and unit test team leads.

6.10 Approval by Executive Owner and Program Management Executive Owner.

6.11 Internal Alpha release based on defined exit criteria. Pass unit tested code. Sign-off unit tests and pass to system test team.

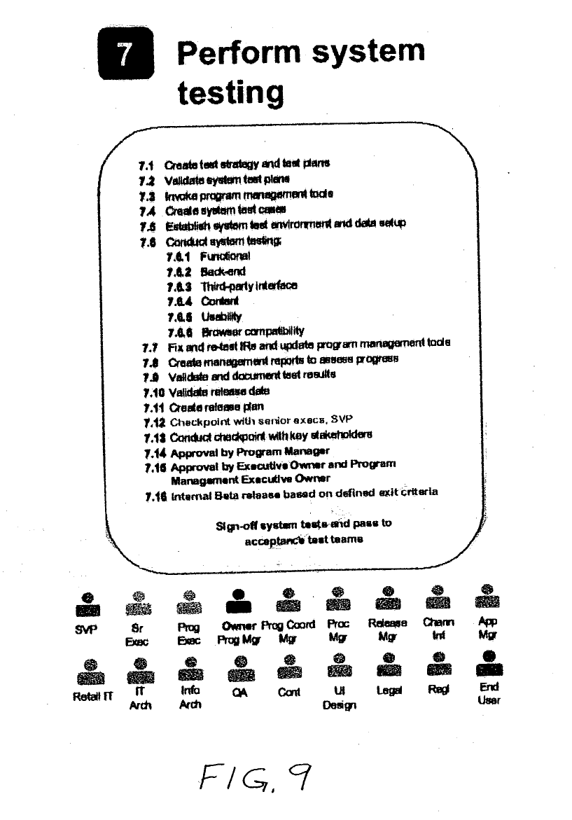

FIG. 9 illustrates the details of step seven in the preferred lifecycle process, the key participants and stakeholders. Step 7 is to Perform system testing. The sub-steps are as follows:

7.1 Create test strategy and test plans. Create overall program level test strategy and test plans for the following test phases: (1) System Test Phase - system, browser, usability and content tests; and (2) Acceptance Test Phase - user acceptance, end-to-end, stress, legal and regulatory tests.

7.2 Validate system test plans.

7.3 Invoke program management tools. Invoke incident reporting, test management, requirements/change management, and configuration management tools according to the defined processes.

7.4 Create system test cases. Create test cases and identify data requirements for the following test efforts:

7.4.1 Functional;

7.4.2 Back-end systems;

7.4.3 Third-party interface(s);

7.4.4 Content;

7.4.5 Usability; and

7.4.6 Browser compatibility.

7.5 Establish system test environment and data setup for each test effort.

7.6 Conduct system testing. Conduct tests and enter IR information in the IR management tool for:

7.6.1 Functional;

7.6.2 Back-end;

7.6.3 Third-party interface;

7.6.4 Content;

7.6.5 Usability; and

7.6.6 Browser compatibility.

7.7 Fix and re-test IRs and update program management tools for each test effort.

7.8 Create management reports to assess progress for each test effort. Create reports utilizing data from the IR, test management, requirements/change management, and configuration management tools.

7.9 Validate and document test results for each test effort.

7.10 Validate release date based on implemented requirements, test results and IR analysis.

7.11 Create release plan addressing the following areas: staging plan; release plan and checklist; training plan; communication and rollout plan; service level agreements; metrics; and associated costs.

7.12 Checkpoint with senior execs, SITE. Review system test results and exit criteria. Document all issues and risks identified during review.

7.13 Conduct checkpoint with key stakeholders. Review program status and answer all unresolved concerns. Document all issues and risks identified during review.

7.14 Approval by Program Manager. Sign-off document should be signed by the program manager and system test team leads.

7.15 Approval by Executive Owner and Program Management Executive Owner. Sign-off document should be signed by the Executive Owner and the Program Management Executive Owner.

7.16 Internal Beta release based on defined exit criteria. Pass system tested code. Sign-off system tests and pass to acceptance test teams.

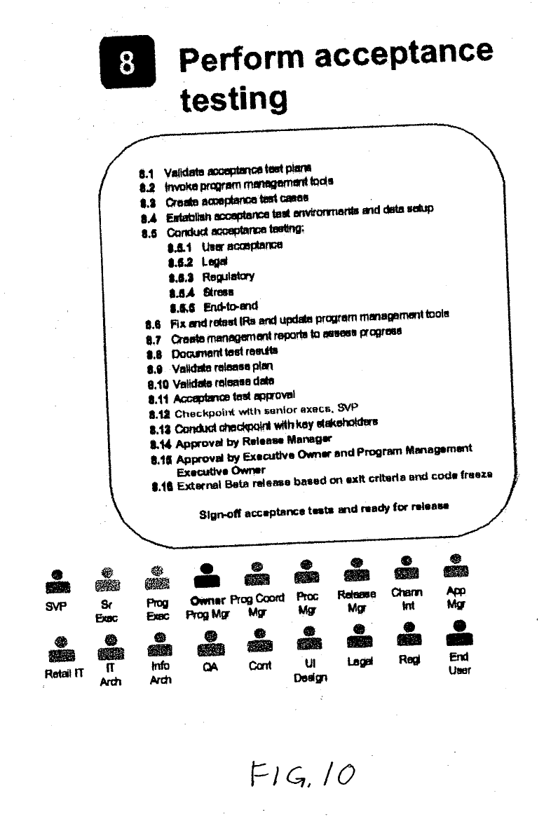

FIG. 10 illustrates the details of step eight in the preferred lifecycle process, including the key participants and stakeholders. Step 8 is to Performance acceptance testing. The sub-steps are as follows:

8.1 Validate acceptance test plans.

8.2 Invoke program management tools. Invoke incident reporting, test management, requirements/change management, performance management, and configuration management tools according to the defined processes. Set up each test effort on the appropriate tool.

8.3 Create acceptance test cases. Create test cases and identify data requirements for the following test efforts:

8.3.1 User acceptance;

8.3.2 Legal;

8.3.3 Regulatory;

8.3.4 Stress; and

8.3.5 End-to-end incl. third party interfaces.

8.4 Establish acceptance test environments and data setup for each test effort.

8.5 Conduct acceptance testing. Conduct tests and enter IR information in the IR management system for:

8.5.1 User acceptance;

8.5.2 Legal;

8.5.3 Regulatory;

8.5.4 Stress; and

8.5.5 End-to-end incl. third party interfaces.

8.6 Fix and retest IRs and update program management tools for each test effort.

8.7 Create management reports to assess progress for each test effort. Create reports utilizing data from the IR, test management, requirements/change management, and configuration management tools.

8.8 Document test results for each test effort.

8.9 Validate release plan.

8.10 Validate release date based on acceptance test results and IR analysis.

8.11 Acceptance test approval based upon test plan exit criteria:

8.11.1 User acceptance;

8.11.2 Legal;

8.11.3 Regulatory;

8.11.4 Stress; and

8.11.5 End-to-end incl. third party interfaces.

8.12 Checkpoint with senior execs, SITE. Review acceptance test results and exit criteria. Document all issues and risks identified during review.

8.13 Conduct checkpoint with key stakeholders. Review program status and answer all unresolved concerns. Document all issues and risks identified during review.

8.14 Approval by Release Manager. Sign-off document should be signed by the release manager and acceptance test team leads.

8.15 Approval by Executive Owner and Program Management Executive Owner. Sign-off document should be signed by the Executive Owner and the Program Management Executive Owner.

8.16 External Beta release based on exit criteria and code freeze. Pass acceptance tested code. Sign-off acceptance tests and ready for release.

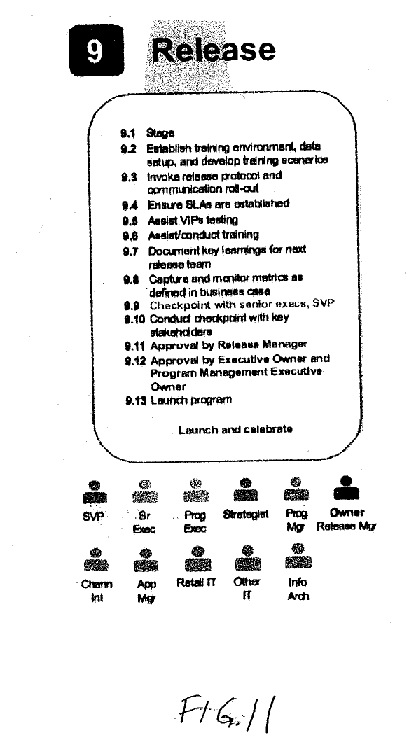

FIG. 11 illustrates the details of step nine in the preferred lifecycle process, including the key participants and stakeholders. Step 9 is to Release the program to an end user. The sub-steps are as follows:

9.1 Stage. Establish staging environment, migrate code, and data set-up.

9.2 Establish training environment, data setup, and develop training scenarios and user manuals.

9.3 Invoke release protocol and communication roll-out.

9.4 Ensure service level agreements (“SLAs”) are established.

9.5 Assist production support group testing.

9.6 Assist/conduct training.

9.7 Document key learnings for next release team.

9.8 Capture and monitor metrics as defined in business case.

9.9 Checkpoint with senior execs, SITE. Review launch ready status. Document all issues and risks identified during review.

9.10 Conduct checkpoint with key stakeholders. Review program status and answer all unresolved concerns. Document all issues and risks identified during review. Review key learnings and metrics.

9.11 Approval by Release Manager. Sign-off document should be signed by the release manager assuring that program is ready for launch.

9.12 Approval by Executive Owner and Program Management Executive Owner. A sign-off document should be signed by the release manager assuring that program is ready for launch.

9.13 Launch program. Send out email distribution to all program members announcing successful launch of the program.

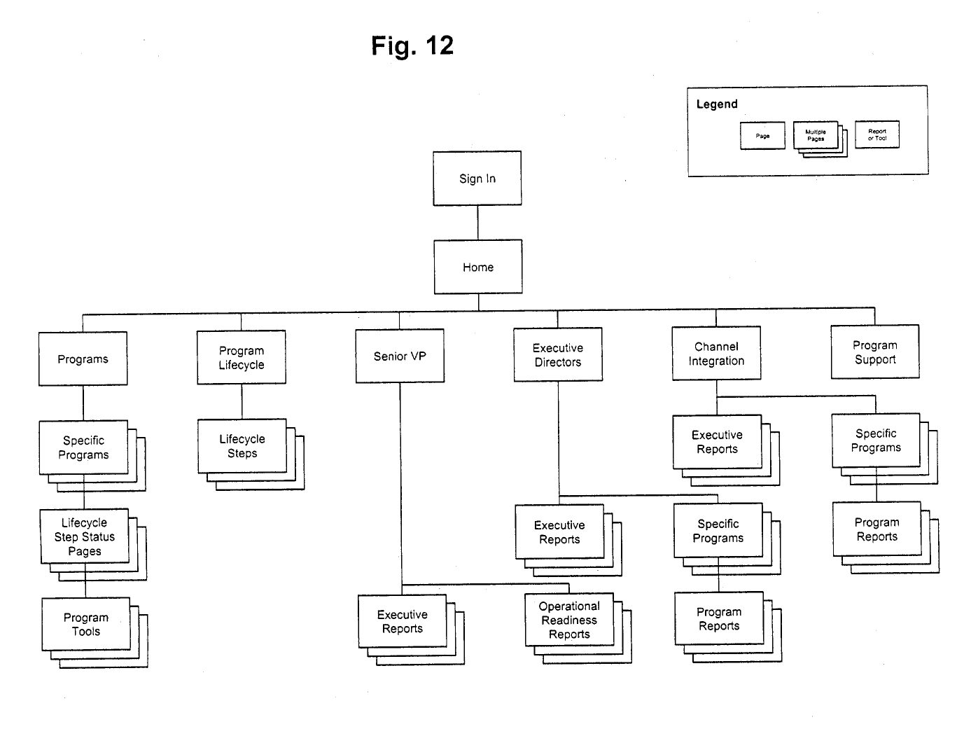

FIG. 12 is a block diagram that illustrates an exemplary URL site map according to a preferred embodiment of the present invention.

The system for program lifecycle management described in the text above was chosen as being illustrative of the best mode of the present invention. All embodiments of the present invention described above all illustrative of the principles of the invention and are not intended to limit the invention to the particular embodiments described. Accordingly, while the preferred embodiment of the invention has been illustrated and described, it will be appreciated that various changes can be made therein without departing from the spirit and scope of the invention as claimed.

What is claimed is:

1. A data processing system for enabling at least one stakeholder to manage a project that includes the generation of at least one software program for an end user, comprising:
a program lifecycle management processor for prompting at least one participant to perform a plurality of tasks such that said at least one participant is guided through a lifecycle process for generating said software program and for enabling at least one stakeholder to monitor and oversee said project and the progress of said software program generation for said project;
a user interface for enabling role-based access to said data processing system for said participant and said stakeholder and for enabling said participant and said stakeholder to input data to said lifecycle management processor and access data from said lifecycle management processor according to said role-based access.

2. The data processing system of claim 1, wherein said lifecycle process comprises the steps of:
(1) prompting said participant to identify and describe a program concept, said lifecycle management processor enabling said participant to proceed to the next step in said lifecycle process when said program concept satisfies at least one predetermined criterion;
(2) prompting said participant to define the desired scope and functionality of said program, said lifecycle management processor enabling said stakeholder to evaluate said program scope and functionality and to proceed to the next step in said lifecycle process when said stakeholder determines that said program scope and functionality are feasible;
(3) prompting said participant to establish a priority for completing said program, said lifecycle management processor enabling said participant to proceed to the next step in said lifecycle process once priority has been established based on at least one predetermined criterion;
(4) prompting said participant to identify tools to be used in implementing said program;
(5) prompting said participant to identify the detailed requirements for said program and to create a detailed functional and module level work plan for said program using said tools, said lifecycle management processor enabling said stakeholder to evaluate said detailed requirements and said detailed functional and module level work plan and enabling said participant to proceed to the next step in said lifecycle process when said stakeholder determines that said work plan satisfies said detailed requirements;
(6) prompting said participant to develop the completed program using said detailed requirements and said tools;
(7) prompting said participant to create a systems test strategy and plan for said completed program and to perform system testing based on said systems test plan, said lifecycle management processor enabling said participant to proceed to the next step in said lifecycle process when said program satisfactorily performs pursuant to said systems test plan; and
(8) prompting said participant to create an acceptance test plan for said completed program and to perform acceptance testing based on the acceptance test plan, said lifecycle management processor enabling said participant to proceed to the next step in said lifecycle process when said program satisfactorily performs pursuant to said acceptance test plan.

3. The data processing system of claim 2, said lifecycle process, implemented by said lifecycle management processor, further comprising the step of:
(9) prompting said participant to perform at least one additional predetermined task prior to the release of said program to said end user.

4. The data processing system of claim 1, wherein said data input by said participant and said stakeholder includes data input as said lifecycle management processor guides said participant through said lifecycle process.

5. The data processing system of claim 1, further comprising at least one data storage unit for storing and providing access to data input by said participant and said stakeholder via said user interface.

6. The data processing system of claim 1, wherein said at least one program is one of a plurality of programs of said project and said data processing system is operative for managing and generating each said program in said project.

7. The data processing system of claim 1, further comprising a plurality of software tools for managing said project and for implementing said lifecycle process.

8. The data processing system of claim 7, wherein said data processing system enables data to be input to and accessed from a data storage unit by each of said plurality of software tools, such that said data processing system enables said participant and said stakeholder to have role based access to said plurality of software tools via said user interface through said data storage unit for using each said software tool.

9. The data processing system of claim 7; wherein said plurality of software tools includes;
an incident report (“IR”) tracking and issue management/tracking tool;
a configuration management tool;
a requirements management tool;
a workplan and deliverables tool;
a test management tool;
a regression testing tool; and
a performance management tool.

10. The data processing system of claim 7, wherein said plurality of software tools includes a finance tool.

11. The data processing system of claim 7, wherein said plurality of software tools includes a metrics tool, wherein the metrics comprise steps used to verify a particular performance measurement of said program generation.

12. The data processing system of claim 7, wherein said plurality of software tools includes a calendar and meeting tool for enabling said stakeholder to generate and manage a calendar and meetings for managing said program generation.

13. The data processing system of claim 7, wherein said plurality of software tools includes a communication tool for enabling communication between said participants and said stakeholder.

14. The data processing system of claim 1; further comprising a central deliverables repository such that all program deliverables may be accessed through said lifecycle management processor.

15. The data processing system of claim 14, wherein said plurality of software tools includes a document management tool for enabling said participant and said stakeholder to view and access files from a central deliverables repository, said view and access being restricted based on the role assigned to said participant and said stakeholder.

16. The data processing system of claim 1, further comprising a reporting engine for enabling the publishing of real-time reports from data gathered by said system.

17. The data processing system of claim 1, wherein said program lifecycle management processor enables users to have role-based access to said predefined views of the status of said program generation.

18. The data processing system of claim 17, wherein said lifecycle management processor enables users to have role-based access for real-time status monitoring of said software program generation by said stakeholder.

19. The data processing system of claim 17, wherein said program lifecycle management processor enables a role-based predetermined view of the status of said project and said program generation for each participant and stakeholder via the internet so as to provide a real time snapshot of the status for said participant and said stakeholder.

20. The data processing system of claim 1, wherein enabling said role-based access for controlling the ability of said participants and said stakeholders to view said status and execute said program generation comprises the following steps:
causing said stakeholder to assign roles to each said participant and said stakeholder in order to restrict access to a subset of said information based on said assigned role;
causing said stakeholder to establish predetermined security for each assigned role such that the levels of detail about said program and said program status that is accessible to said participant and said stakeholder is predetermined for said assigned role; and
enabling said participant and said stakeholder to select one of the predetermined levels of detail enabled for said assigned role of said participant and stakeholder.

21. The data processing system of claim 1, wherein said program lifecycle management processor provides templates and examples of the best-practices in program lifecycle management for use by said participant and said stakeholder.

22. The data processing system of claim 1, wherein said user interface enables use of said program lifecycle management processor by said participant and said stakeholder from multiple geographic locations.

23. The data processing system of claim 22, wherein said user interface is via the internet using a personal computer.

24. The data processing system of claim 22, wherein said user interface is via the internet using a browser-based, thin client device.

25. A data processing system for enabling a plurality of stakeholders to manage a project that includes the generation of one or more software programs for an end user, said data processing system operative for managing each said program being generated for said project, said data processing system comprising:
a program lifecycle management processor for prompting a plurality of participants to perform a plurality of tasks such that each said participant is guided through a lifecycle process for generating each said software programs and for enabling said stakeholder to monitor and oversee the progress of said software program generation and for enabling a preselected number of said stakeholders to manage the progress of said project;
a user interface for enabling role-based access to said data processing system for each said participant and each said stakeholder and for enabling each said participant and each said stakeholder to input data to said lifecycle management processor and access data from said lifecycle management processor according to said role-based access; said user interface enabling use of said program lifecycle management processor by each said participant and each said stakeholder from multiple geographic locations via the internet;
a plurality of software tools for managing said project and each said program of said project and for implementing said lifecycle process for each said program; wherein said plurality of software tools includes: an incident report (“IR”) tracking and issue management/tracking tool; a configuration management tool; a requirements management tool; a workplan and deliverables tool; a test management tool; a regression testing; a performance management tool, a finance tool, a metrics tool; a documents management tool; a calendar and meeting tool, and a communications tool;
at least one data storage unit for storing and providing access to data input by said participant and said stakeholder via said user interface for managing each said data storage unit and access thereto, wherein said data processing system enables data to be input to and accessed from said data storage unit by each of said plurality of software tools, such that said data processing system enables each said participant and each said stakeholder to have role based access to each said software tool via said user interface;
a central deliverables repository such that all program deliverables may be accessed through said lifecycle; said documents management tool enabling each said participant and said stakeholder to view and access files from said central deliverables repository, said view and access being restricted based on the role assigned to said participant and said stakeholder;
a reporting engine for enabling the publishing of real-time reports from data of said system;
wherein said program lifecycle management processor enables users to have role-based access to one or more predetermined views of the status of said project and said program generation via the internet so as to provide a real time snapshot of the status for each said participant and each said stakeholder; said program lifecycle management processor providing templates and examples of the best-practices in program lifecycle management for use by each said participant and each said stakeholder.

26. The data processing system of claim 25, wherein said user interface enables use of said program lifecycle management processor on a personal computer by each said participant and each said stakeholder from multiple geographic locations via the internet.

27. The data processing system of claim 25, wherein said user interface enables use of said program lifecycle management processor on a browser-based, thin client device by each said participant and each said stakeholder from multiple geographic locations via the internet.

28. The data processing system of claim 25, wherein said data processing system enables at least one of said stakeholders to assign roles to each said participants and each said stakeholder and to establish predetermined security for each assigned role, such that the levels of detail about each said project, each said program, and said program status that is accessible to said participant and said stakeholder is predetermined for said assigned role, and said data processing system enables one or more predetermined levels of detail about said program for preselected assigned roles of said stakeholders and enabling said stakeholders in said preselected assigned roles to selectively view one or more predetermined levels of detail about said project and said program.
